(19) United States
(12) Patent Application Publication
(10) Pub. No.: US 2005/0201822 A1
(43) Pub. Date: Sep. 15, 2005

(54) Fixing device

(76) Inventor: Michael Hahner, Sindelfingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/513,684

(22) PCT Filed: Apr. 11, 2003
(86) PCT No.: PCT/EP03/03807

§ 371 Date: May 20, 2005

(30) Foreign Application Priority Data
May 8, 2002 (DE) 10220539.6

(51) Int. Cl. F16D 1/12

(52) U.S. Cl. 403/53

(57) ABSTRACT

A device for fixing a component has a rigid base body between a first abutment and a second abutment, which are in each case rigid. A rigid connection of the base body to the first abutment is to be designed in a structurally simple manner for a possible compensation of tolerances in relation to different distances between the abutments. For this purpose, the base body is connected to the second abutment in a flexible manner in the direction of the distance between the two abutments and in a rigid manner in all other directions.

### BACKGROUND AND SUMMARY OF THE INVENTION

This invention relates to a fixing device.

In practice, a device of this type is present, for example, when a lock is fitted in a tailgate of a motor vehicle. A lock housing is to be fitted as a rigid body there between an inner panel and an outer panel of the tailgate. The lock housing is to be connected rigidly to the outer panel at a specified assigned location by means of a screw connection, for example. The inner panel is provided with an additional support which takes place, for example, by means of a screw connection on the inner panel, to be precise in a region in which the inner panel runs parallel to the outer panel.

The distance between the inner panel and the outer panel has relatively large variations in size of up to a few millimeters caused by production. There is therefore the problem of compensation of tolerances in the situation in which a form-fitting connection of the lock housing to the inner panel is desired in the direction of the distance between the two panels. This problem has previously been solved in practice by a tolerance-compensating double spline being inserted between the bearing surfaces of the lock and of the inner panel, in the region in which these two parts are screwed together.

Taking this as the starting point, the invention is concerned with the problem, in the case of the fixing device of the generic type, of finding a structurally at least equivalent solution which is provided by a device designed according to the invention.

Expedient and advantageous refinements of the invention are the subject matter of dependent claims.

The invention is based on the general concept of providing, on the critical abutment on which a compensation of tolerances is to be undertaken in the direction of the distance between the two abutments, a connecting element between the abutment and base body, which connecting element is flexible exclusively in the abovementioned direction of the distance.

In the simplest case, this connecting element can be, for example, a flexible sheet-metal or plastic strip, the relevant material, although being flexible, having to be made stiff to tensile and compressive forces in the plane of the strip. A flexible strip of this type may be molded onto the base body or onto the relevant abutment assigned to the latter. A connection of the connecting element which is pivotable in the direction of the distance between the two abutments has to be provided on at least one of the two connected parts.

The connecting element may comprise, in particular, two sub-elements which can be pivoted in relation to each other via an axis.

Since bending or pivoting of the single- or multi-part connecting element is required to compensate for different distances between the abutments, the length between the connecting regions changes perpendicularly to the direction of the distance between the two abutments. A compensation of the length between the connecting element and the base body or the abutment therefore has to be possible in the direction perpendicular to the direction of the distance between the two abutments. In the case of a screw connection of the connecting element with respect to one of the two abovementioned parts, this can take place by appropriate design of the passage openings for the connecting screw or openings for a plurality of screws.

If the base body is formed from plastic, a connecting element, which is divided into two sub-elements, can be designed as a film hinge in the required pivoting regions.

The connecting element may also be designed as a flexible tab which is formed in the relative abutment and has, for example, a slot for compensating the length in the direction transversely to the direction of the distance between the abutments for a screw connection. This design is suitable in particular for the case in which the relevant abutment is a panel, such as, for example, in the case of the abovementioned tailgate of a vehicle.

Expedient and advantageous refinements of the invention are illustrated by way of example in the drawings.

### BRIEF DESCRIPTION OF THE DRAWINGS

FIG. 1 shows a component fixed between two abutments, in section, and

FIG. 2 shows a tab-like, flexible connecting element formed from a panel as the abutment, in plan view.

### DETAILED DESCRIPTION OF THE INVENTION

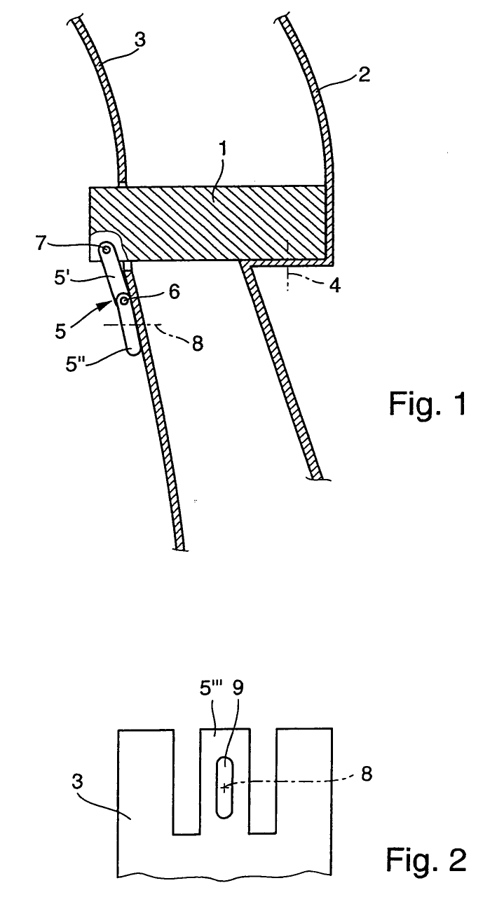

FIG. 1 schematically illustrates the situation in which a lock housing is fitted between an inner and an outer panel of a vehicle tailgate. In this case, the lock housing corresponds to the basic body 1 and the outer and inner panel of the tailgate correspond to the first and second abutments 2, 3 in respect of the terms used in the invention.

The base body 1 is screwed rigidly to the first abutment 2, which is indicated in the drawing by a screwing central line 4.

The base body 1 is screwed to the second abutment 3 via a connecting element 5, which is composed of a first sub-element 5′ and a second sub-element 5″. The two sub-elements 5′ and 5″ consist in each case of stiff material. The first sub-element 5′ is mounted in a manner such that it can pivot in the direction of the distance between the two abutments 2 and 3 in an axis of rotation 7 on the base body 1. The second sub-element 5″ is mounted pivotably on the first sub-element 5′ via an axis of rotation 6 parallel to the axis of rotation 7. The second sub-element 5″ is screwed onto the abutment 3, for which purpose a slot is provided in the second sub-element 5″ and/or the abutment 3 transversely to the direction of the distance between the two abutments 2, 3, to pass a fastening screw through. The fastening screw is indicated merely schematically by a screw centre line 8 in the drawing. A two-part construction with an articulated intermediate connection of the connecting element 5 makes it possible in a simple manner for distance tolerances between the abutments 2 and 3 to be compensated for. In a design of the base body from 1, the connecting element 5 can be designed in a particularly simple manner together with the sub-elements 5′ and 5″ as a film hinge.

As FIG. 2 shows, the connecting element 5 may also be formed in the abutment 3 in the form of a flexible tab 5′″ together with a slot 9 in this tab 5′″ if said abutment consists, for example, of a leaf-like material, such as, for example, sheet metal.

1-5. (canceled)

6. A fixing device for fixing a component having a rigid base body between a rigid first abutment and a rigid second abutment, comprising:
a first rigid connection of the base body to the first abutment, and
a second connection of the base body to the second abutment,
wherein the base body and the second abutment are connected in a flexible manner in a direction of a distance between the first and second abutments and in a rigid manner in all other directions.

7. The fixing device as claimed in claim 6, wherein the second connection includes a connecting element which is provided between the base body and the second abutment, wherein said connecting element comprises a first sub-element and a second sub-element, wherein the first and second sub-elements are pivotable in relation to each other about a common first axis of rotation, wherein the first sub-element is coupled to the second abutment or the base body so that it can pivot about a second axis of rotation parallel to the first axis of rotation, and wherein the second sub-element is connected rigidly to one of the abutments or the base body but not to the second abutment or the base body to which the first sub-element is coupled.

8. The fixing device as claimed in claim 7, wherein the second sub-element is screwed to the base body or to the abutment, wherein a passage opening for at least one screw in each case is provided in one of the two parts which are screwed to each other, and wherein said passage opening, when a screw is inserted or screws are inserted but not yet tightened, permits a relative movement transversely to the direction of the distance between the two abutments.

9. The fixing device as claimed in claim 6, wherein the second connection includes a connecting element which is provided between the base body and the second abutment and is a continuous, leaf-like, single-part component.

10. The fixing device as claimed in claim 7, wherein at least one of the sub-elements is molded on the base body, molded on one of the abutments, formed from the base body, or formed from one of the abutments.

11. The fixing device as claimed in claim 8, wherein at least one of the sub-elements is molded on the base body, molded on one of the abutments, formed from the base body, or formed from one of the abutments.

12. The fixing device as claimed in claim 9, wherein one end of the connecting element is molded on the base body, molded on one of the abutments, formed from the base body, or formed from one of the abutments.
